(19) United States
(12) Patent Application Publication
(10) Pub. No.: US 2008/0252629 A1
(43) Pub. Date: Oct. 16, 2008

(54) Display apparatus and brightness correction method thereof

(75) Inventor: Ching-Yueh Chiang, Taoyuan (TW)

Correspondence Address: BACON & THOMAS, PLLC, 625 SLATERS LANE, FOURTH FLOOR, ALEXANDRIA, VA, 22314-1176, US

(73) Assignee: Qisda Corporation, Taoyuan (TW)

(21) Appl. No.: 12/078,589

(22) Filed: Apr. 2, 2008

(30) Foreign Application Priority Data
Apr. 14, 2007 (TW) 96113250

(51) Int. Cl. G09G 5/00; G09G 5/10; G09G 3/30

(52) U.S. Cl. 345/207; 345/690; 345/77

(57) ABSTRACT

A display apparatus and a brightness correction method thereof are provided. The display apparatus includes a body and a light sensing device. The body includes a screen and a control module and the control module is coupled to the screen for controlling brightness of the screen. The light sensing device, coupled to the body through a cable, is used for sensing brightness so as to generate a detected brightness value accordingly, wherein the control module receives the detected brightness value through the cable.

This application claims the benefit of Taiwan application Serial No. 96113250, filed Apr. 14, 2007, the subject matter of which is incorporated herein by reference.

### BACKGROUND OF THE INVENTION

1. Field of the Invention

The invention relates in general to a display apparatus and a brightness correction method thereof and more particularly to a display apparatus which adjusts its brightness with respect to a target light source directly and a brightness correction method thereof.

2. Description of the Related Art

In professional fields demanding displays with higher display performance, such as art design, advertising design or publishers, the required quality of their end products can be achieved only if the displays for work have the same display setting parameters, e.g. brightness and colors. Thus, they may need to possess detection equipment, e.g. signal pattern generators, for performing corresponding correction on their own or require the display manufacturers to perform correction of the displays in advance when placing an order for the displays. However, such detection equipment is still expensive currently and does not provide the function of directly mapping and converting the parameters of two displays automatically. After the displays leaving the factory with initial correction, the display performance will deteriorate naturally with time. In this case, if no corresponding detection equipment is available, the adjustment among the displays after purchase can only be done by sending back the displays to the manufactory, or by manual ways to perform correction with visual detection among the displays, thus making it difficult to make balance between the cost and quality of correction.

### SUMMARY OF THE INVENTION

The invention is directed to a display apparatus and a brightness correction method thereof. Brightness correction can be done with respect to a target light source by using a light sensing device of the display apparatus directly so that the brightness of the display apparatus can be adjusted to the brightness that is needed with high precision and acceptable cost.

According to a first aspect of the invention, a display apparatus is provided, including a body and a light sensing device. The body includes a screen and a control module and the control module is coupled to the screen for controlling brightness of the screen. The light sensing device, coupled to the body through a cable, is used for sensing brightness so as to generate a detected brightness value accordingly, wherein the control module receives the detected brightness value through the cable.

According to a second aspect of the invention, a brightness correction method is provided for a display apparatus. The display apparatus includes a body having a screen and a light sensing device coupled to the body through a cable. The method includes the following steps. (a) Brightness of a light source is detected by using the light sensing device to generate a target brightness value. (b) Brightness of the screen is detected by using the light sensing device to generate a screen brightness value. (c) A determination is made as to whether the target brightness value corresponds to the screen brightness value; if not, step (d) (d) The brightness of the screen is adjusted.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIGS. 1A and 1B illustrate a display apparatus according to a preferred embodiment of the invention.

FIG. 1C illustrates a light sensing device light sensing device 120 detecting the brightness of a light source.

FIG. 1D illustrates a light sensing device light sensing device 120 detecting the brightness of a screen.

FIG. 2 is a flowchart illustrating a method for brightness correction for the display apparatus 100 according to the preferred embodiment of the invention.

### DETAILED DESCRIPTION OF THE INVENTION

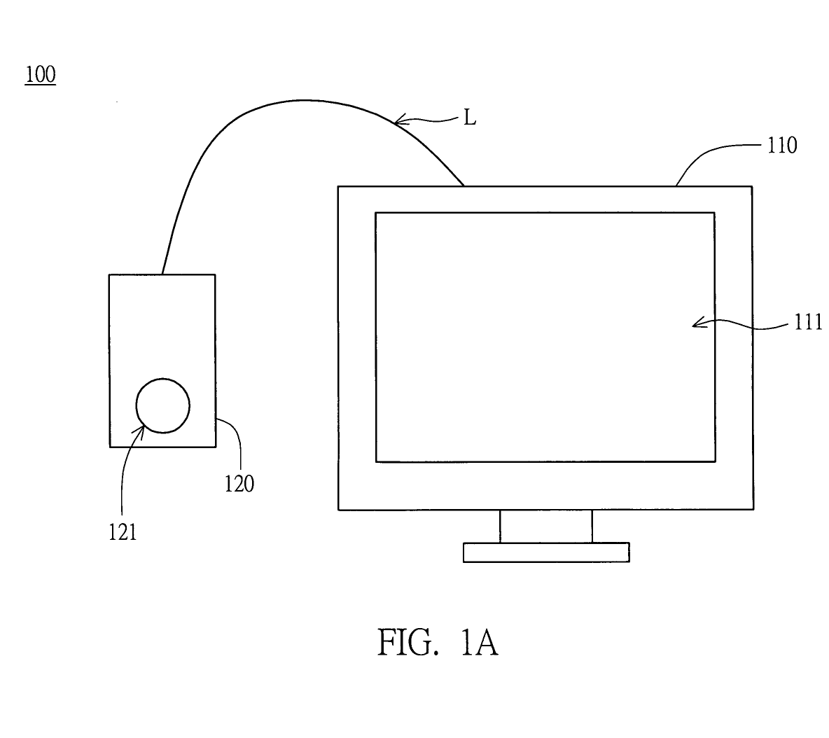

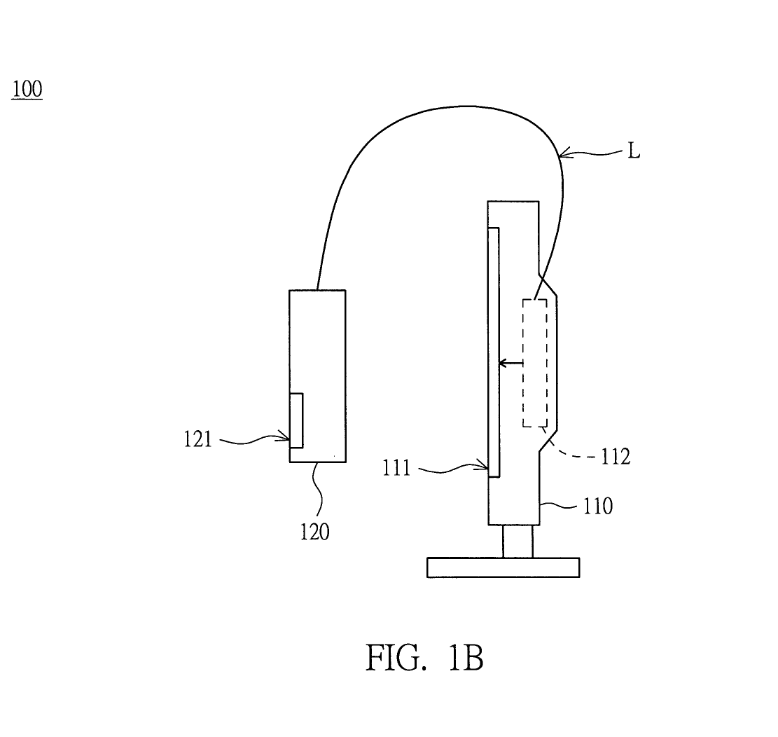

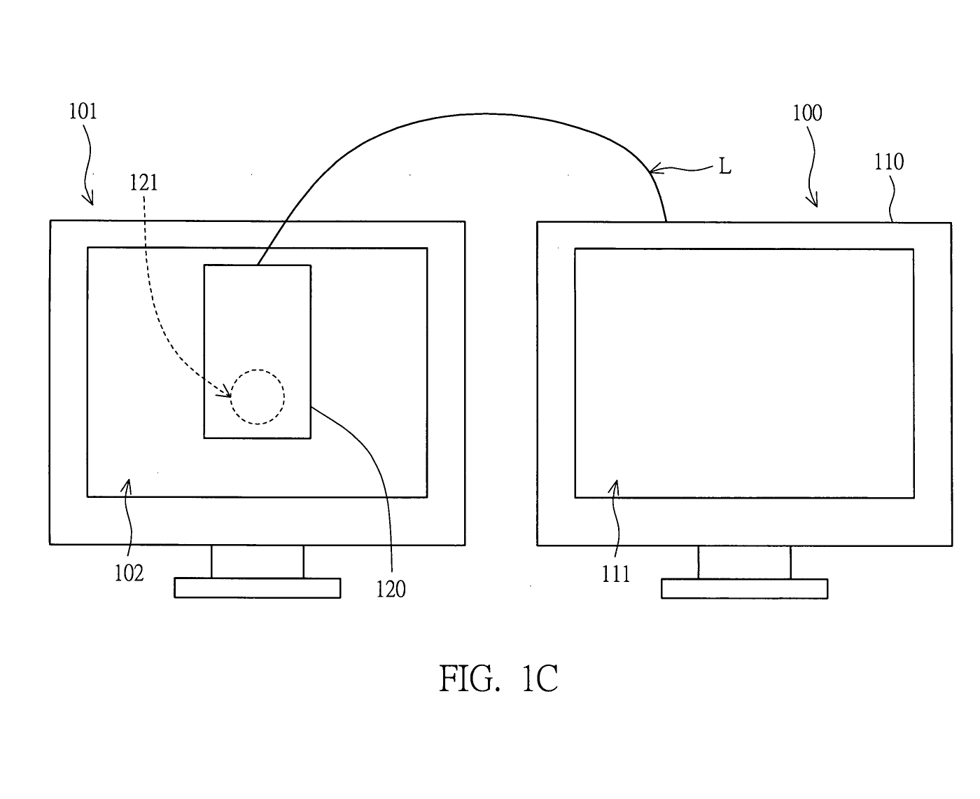

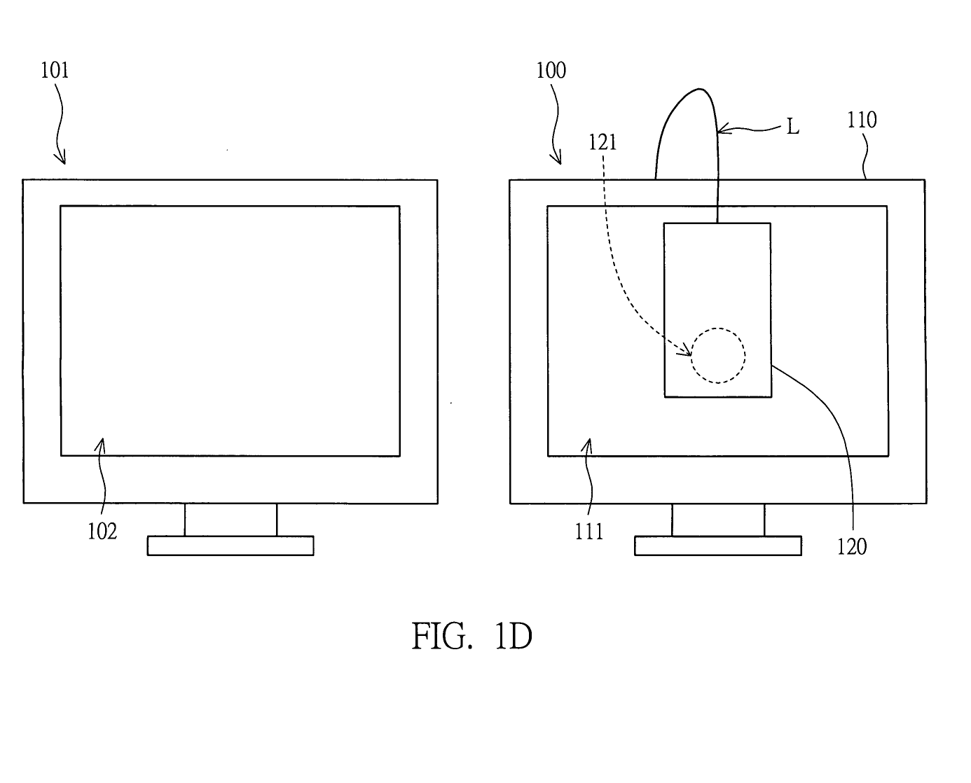

Referring to FIGS. 1A and 1B, a display apparatus according to a preferred embodiment of the invention is illustrated. The display apparatus 100 includes a body 110 and a light sensing device 120 and the light sensing device 120 is coupled to the body 110 through a cable L. As shown in FIG. 1A, the front face of the body 110 has a screen 111 for displaying images and a user can adjust the display parameters, such as brightness or contrast, of the screen 111 by using controls of the body 110, e.g. buttons or switches. In addition, as illustrated in FIG. 1B, which is a side view of FIG. 1A, the body 110 further includes a control module 112 coupled to the screen 111 for controlling the brightness of the screen 111. The light sensing device 120 senses brightness by a light receiving device 121 so as to generate a detected brightness value according to the brightness sensed by the light receiving device 121, wherein the control module 112 receives the detected brightness value through the cable L.

In this embodiment, the display apparatus 100 is exemplified by a liquid crystal display (LCD) apparatus and the screen 111 includes an LCD panel. The control module 112 includes a backlight module, such as bottom-lighting or edge-lighting structure, that provides the back light for the screen 111 of the LCD panel. The light sensing device 120 senses a light signal, e.g. indicating brightness, and converts the light signal to an electrical signal, e.g. indicating a detected brightness value, by using a charge coupled device (CCD) or a complementary metal-oxide semiconductor (CMOS), for example. In addition, the cable L can be detachably connected to the body 110. That is, when it is required, the cable L is used to connect the light sensing device 120 to the body 110 so that the control module 112 can receive the sensed signal. Specifically, the control module 112 changes driving parameters for the internal backlight module to generate back light at different brightness according to a signal fed back from the light sensing device 120 indicating a brightness value, thereby rectifying the brightness of the screen 111.

As an example, a user can use control buttons or other input device on the light sensing device 120 and the computer to switch the operation mode of the display apparatus 100 by way of software control approach. When the display apparatus 100 is switched to a detection mode, the control module 112 stores or buffers the detected brightness value received from the light sensing device 120 as a target brightness value. When the display apparatus 100 is switched to an adjustment mode, the light sensing device 120 performs detection again so as to generate a latest detected brightness value.

Further, in the adjustment mode, the control module 112 compares the latest detected brightness value with the target brightness value. If the latest detected brightness value is smaller than the target brightness value, the control module 112 increases driving current or voltage for the backlight module so that the light source of the backlight module, such as one formed by fluorescent tube or light emitting diode, emits light with higher brightness, thus increasing the brightness of the screen 111. Conversely, if the latest detected brightness value is larger than the target brightness value, the control module 112 decreases driving current or voltage for the backlight module accordingly so that the light source of the backlight module emits light with lower brightness, thus reducing the brightness of the screen 111. Accordingly, a user can use the light sensing device 120 conveniently to rectify the brightness of the screen 111 to desired performance of brightness.

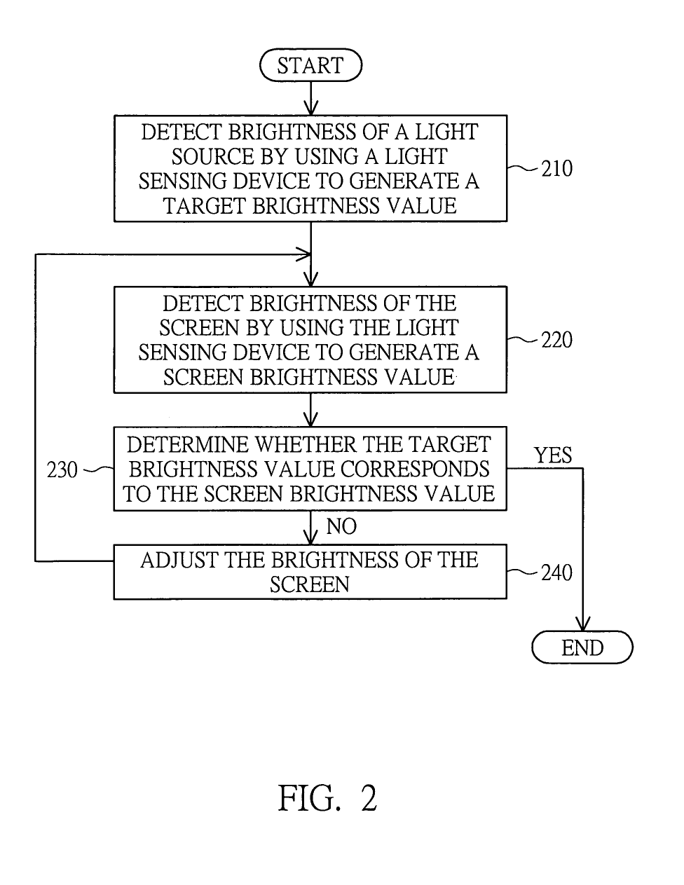

Referring to FIG. 2, a method for brightness correction for the display apparatus 100 is shown according to the preferred embodiment of the invention in flowchart form. Firstly, in step 210, the brightness of a light source is detected by using the light sensing device 120 to generate a target brightness value. Please refer to FIG. 1C, in which the screen 102 of another display apparatus 101 can be taken as an example of the light source. For example, the user can make the light receiving device 121 of the light sensing device 120 remain or stick on the screen 102 of the display apparatus 101, as indicated by a dashed circle facing the screen 102, as shown in FIG. 1C, and can switch the display apparatus 100 to the detection mode for detection, as mentioned above. The control module 112 of the display apparatus 100 then receives a sensed signal that represents the brightness of brightness of the screen 102 of the display apparatus 101, and stores or buffers the sensed signal as a target brightness value B0.

After that, in step 220, the brightness of the screen 111 is detected by using the light sensing device 120 to generate a screen brightness value. Please refer to FIG. 1D. For example, the user can make the light receiving device 121 of the light sensing device 120 remain or stick on the screen 111 of the display apparatus 100, as indicated in FIG. 1D, and can switch the display apparatus 100 to the adjustment mode for detection, as mentioned above. The control module 112 of the display apparatus 100 then receives a sensed signal that represents the brightness of the screen 111 of the display apparatus 100, and stores or buffers the sensed signal as a target brightness value B1.

After that, in step 230, a determination is made as to whether the target brightness value corresponds to the screen brightness value by comparison. When it is determined that the target brightness value B1 is equal to the target brightness value B0, it indicates that the brightness of the screen 111 can be regarded as the same as the brightness of the screen 102 to which it is desired to correspond, under the prerequisite that the sensitivity of the light sensing device 120 and processing capability of the control module 112 remain unchanged. In addition, if it is determined that the target brightness value B1 is greater or less than the target brightness value B0, the control module 112 performs step 240, as exemplified by the method mentioned above to correspondingly change the driving parameters of the backlight module, so as to decrease or increase the brightness of the screen 111. After the adjustment, the display apparatus 100 maintains the adjustment mode and repeats steps 220 and 230, while the light sensing device 120 is kept in the position as illustrated in FIG. 1D, so that the screen brightness value, which represents the brightness of the screen 111, can be adjusted gradually to correspond to the target brightness value B0. That is, the brightness of the screen 111 can be rectified eventually to correspond to the brightness of the screen 102.

In another embodiment, the display apparatus can be an organic light emitting diode (OLED) display and the screen of its body includes a self-emissive display panel formed by an array of OLEDs. The brightness of the screen is determined by the luminous intensity of the internal OLEDs. The control module of the OLED display includes corresponding circuitry for controlling driving parameters of each OLED so as to control the brightness of the screen. The brightness of the screen can be rectified to correspond to the brightness of the target light source by using the light sensing device and the control module adjusting the brightness of the screen according to the feedback sensed signal, as exemplified by the above-mentioned embodiment. For example, the user can also use the light sensing device to externally detect the current brightness of the screen, as illustrated in FIG. 1D, so that the control module can make comparison with an internal predetermined target value, such as a manufacturing default brightness value, accordingly, and perform brightness compensation on the light source that is decaying naturally in the body. Therefore, the assembly of the display apparatus is simplified as compared with the complicated assembly for the conventional design in which its sensing device is equipped in the backlight module.

Further, the embodiment as shown above has an advantage in term of cost. In this regard, one light sensing device 120 is sufficient to detect the brightness of the screens 111 and 102 in order to rectify the brightness of the screen 111 of the display apparatus 100 to correspond to that of the screen 102 of the display apparatus 101. In term of cost, it is not necessary for each of the display apparatuses 100 and 101 to install one light sensing device 120 accordingly.

Regarding conversion of the light signal to the electrical signal representative of the detected brightness value, the electrical signal can be represented in different forms, such as analog voltages, square wave pulses with different frequencies, or digital signals, in order for the control module to process and analysis. The way of conversion to the electrical signal by the light sensing device can be designed with the consideration of the requirement of detection precision and the hardware performance of the relating processing unit in the control module. In addition, the length of the cable and the position where the cable is detached from or attached to can be designed differently according to the practical applications. For the sake of brevity, the others modifications or modifications that may be derived from the disclosed embodiments will not be mentioned because one having ordinary skill in the art would understand and apply them sufficiently.

As disclosed in the above embodiments, the display apparatus and brightness correction method thereof perform brightness correction with respect to a target light source directly by using a light sensing device externally connected to the body. In this way, the display apparatus can be conveniently adjusted for the required brightness, with higher precision of correction and cost within acceptable ranges.

While the invention has been described by way of examples and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for brightness correction for a display apparatus, the display apparatus including a body having a screen and a light sensing device coupled to the body through a cable detachably, the method comprising:
(a) setting the display apparatus to a detection mode and detecting brightness of a light source by using the light sensing device to generate a target brightness value;
(b) setting the display apparatus to an adjustment mode and detecting brightness of the screen by using the light sensing device to generate a screen brightness value;
(c) determining whether the target brightness value corresponds to the screen brightness value; if not, proceeding to step (d); and
(d) adjusting the brightness of the screen.

2. The method according to claim 1, wherein after step (d) is performed, the method proceeds to the step (b) and step (c).

3. The method according to claim 1, wherein the cable is detachably connected to the body.

4. The method according to claim 1, wherein the light sensing device transmits the target brightness value and the screen brightness value to a control module of the body through the cable, and the control module adjusts the brightness of the screen accordingly.

5. The method according to claim 1, wherein the display apparatus is a liquid crystal display or an organic light emitting diode display.

6. The method according to claim 1, wherein the light sensing device comprises a charge coupled device (CCD) or a complementary metal-oxide semiconductor (CMOS).

7. A display apparatus comprising:
a body comprising:
a screen; and
a control module, coupled to the screen, for controlling brightness of the screen; and
a light sensing device, coupled to the body through a cable detachably, for sensing brightness so as to generate a detected brightness value accordingly, wherein the control module receives the detected brightness value through the cable,
wherein when the display apparatus is in a detection mode, the control module stores the received detected brightness value as a target brightness value; when the display apparatus is in an adjustment mode, the control module stores the received detected brightness value as a screen brightness value and compares the screen brightness value with the target brightness value to control the brightness of the screen accordingly.

8. The display apparatus according to claim 7, wherein when the display apparatus is in the detection mode, if the received detected brightness value is smaller than the target brightness value, the control module increases the brightness of the screen; if the received detected brightness value is greater than the target brightness value, the control module decreases the brightness of the screen.

9. The display apparatus according to claim 7, wherein the cable is detachably connected to the body.

10. The display apparatus according to claim 7, wherein the display apparatus is a liquid crystal display or an organic light emitting diode display.

11. The display apparatus according to claim 7, wherein the light sensing device comprises a charge coupled device (CCD) or a complementary metal-oxide semiconductor (CMOS).
